(19) United States
(12) Patent Application Publication
(10) Pub. No.: US 2006/0163445 A1
(43) Pub. Date: Jul. 27, 2006

(54) Modular framework used to mould concrete test blocks

(76) Inventors: Luigi Branchesi, Cingoli (IT); Stefano Bufarini, Ancona (IT); Nunzio Gagliardini, Jesi (IT); Vincenzo D'Aria, Falconara Marittima (IT)

Correspondence Address: Armstrong Kratz Quintos Hanson & Brooks, 502 Washington Avenue, Suite 220, Townson, MD, 21204, US

(21) Appl. No.: 10/563,381

(22) PCT Filed: Jul. 5, 2004
(86) PCT No.: PCT/IT04/00371

§ 371 Date: Jan. 5, 2006

(30) Foreign Application Priority Data
Jul. 10, 2003 (IT) MC 2003 A 000085

(51) Int. Cl. B28B 7/00

(52) U.S. Cl. 249/117

(57) ABSTRACT

The present invention refers to a modular framework used to mould concrete test blocks, composed of two identical modular semi-shells obtained from moulding suitable plastic materials, with each semi-shell being formed of two vertical borders positioned at 90°, built on the catheti of a lower horizontal triangular wall, each of them having vertical ribs in external position on the free edges, preferably provided with a lower tapered end; it being provided that two semi-shells can be joined by means of suitable rectilinear joints capable of being matched to the ribs.

The present patent application for industrial invention refers to a modular framework used to mould concrete test blocks.

Concrete casting used for reinforced concrete structures must be subjected to a test procedure.

The purpose of the test is to verify that concrete structures comply with strength specifications of the strictest standards.

The test is carried out on parallelepiped blocks obtained by casting a small amount of concrete into suitable frameworks.

The blocks are subjected to close laboratory testing to determine the strength specifications of the building made of concrete.

The normally implemented verification modes require that the parallelepiped test blocks have a perfectly regular structure and, most of all, perfect planarity of the two opposite main faces.

This requirement has always complicated the construction of the framework used to mould test blocks, because of the high resistance of the framework walls required to contain the high pressures discharged onto the walls by concrete casting without suffering any deformation.

With this view it can be stated that none of the existing models of frameworks has proved fully satisfactory.

A first model of framework is characterised by a fully metal sturdy structure, made of modular elements joined by means of suitable fixing brackets during concrete casting. The fixing brackets are then removed as soon as the test block consolidates, to allow for opening the framework completely and extracting the block with ease.

Although this type of framework is generally capable of moulding blocks with perfect parallelepiped shape, it must be noted that it is impaired by the complex and expensive structure, difficult handling and complicated use.

According to another construction principle, another type of framework used to mould test blocks is characterised by a monolithic polystyrene structure of disposable kind.

In this case, the polystyrene framework is broken to release the concrete block moulded in the framework.

Polystyrene frameworks are certainly practical and inexpensive; however, they are impaired by their incapability to withstand the pressures exercised by the concrete casting against the walls.

Very often, the walls of polystyrene conglomerate frameworks are flexed and deformed because of the pressure exercised by the concrete casting, thus impairing the perfect planarity that is required for all test blocks, as mentioned above.

As a matter of fact, the test blocks moulded inside polystyrene frameworks must be normally subjected to a long, expensive procedure, technically known as “face flattening”, aimed at re-establishing the perfect planarity of the faces.

As an additional alternative solution, another type of framework used to mould test blocks is characterised by a monolithic structure of a highly resistant resin that does not suffer any deformation from the pressure exercised by concrete casting.

However, the problem of this type of framework is related to the release of consolidated blocks, since it requires the use of suitable tools to energetically push the blocks out of the framework by means of interference in suitable holes located on the bottom of the framework.

A critical evaluation of the prior technique has led to devise the present invention to obtain a framework characterised by simple construction and easy use, capable of producing test blocks with excellent structural properties that must not be subjected to flattening or finishing.

The new framework of the invention with hollow parallelepiped structure is composed of two identical modular semi-shells obtained from moulting resistant indeformable resin.

Each semi-shell is formed of two adjacent vertical borders positioned at 90° that identify a lower horizontal wall with triangular surface; by matching the two semi-shells, a parallelepiped framework with square plan walls is obtained.

The two semi-shells are then tightened to avoid accidental release during concrete casting.

In particular, the framework is tightened in the area of the two vertical corners that are formed when the free borders of the two semi-shells are joined.

To that end, two suitable sliding joints are used, with each joint being designed to block one of the “open” corners of the framework from the outside.

Practically speaking, each joint is composed of a sort of rectilinear jaw capable of gripping the vertical edge of the border of the first semi-shell and the adjacent vertical edge of the border of the second semi-shell at the same time, thus preventing their accidental release.

It must be noted that the jaw can be inserted into the “open” corner of the framework of the invention thanks to the presence of suitable longitudinal gripping ribs obtained in external position on the adjacent vertical borders of the two semi-shells.

As mentioned above, the rectilinear jaw reaches its operational position by simply sliding, with a translation movement from below upwards with respect to the structure of the framework.

In other words, each joint is matched to the corresponding pair of adjacent borders of the two semi-shells in external position on the framework, by means of a rectilinear travel from the bottom towards the top of the framework.

By simply repeating the insertion operation for each joint, a framework with perfectly parallelepiped shape and excellent technical-functional characteristics is obtained.

Now, concrete can be cast inside the framework to mould test blocks.

Once the blocks consolidate, the framework can be opened to release the blocks by simply removing the two joints in opposite direction with respect to their insertion.

Each joint is pushed from the top downwards, until the borders of the “open” corner of the framework are completely released.

For major clarity the description of the invention continues with reference to the enclosed drawings, which are intended for purposes of illustration only and not in a limiting sense, whereby:

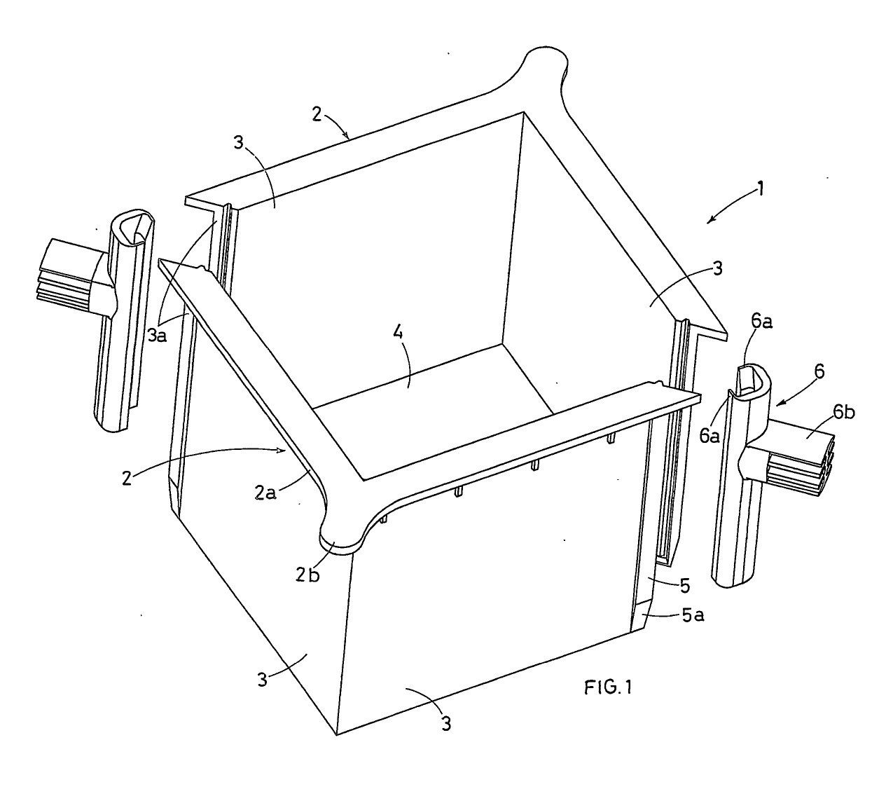

FIG. 1 is an axonometric exploded view of the framework of the invention;

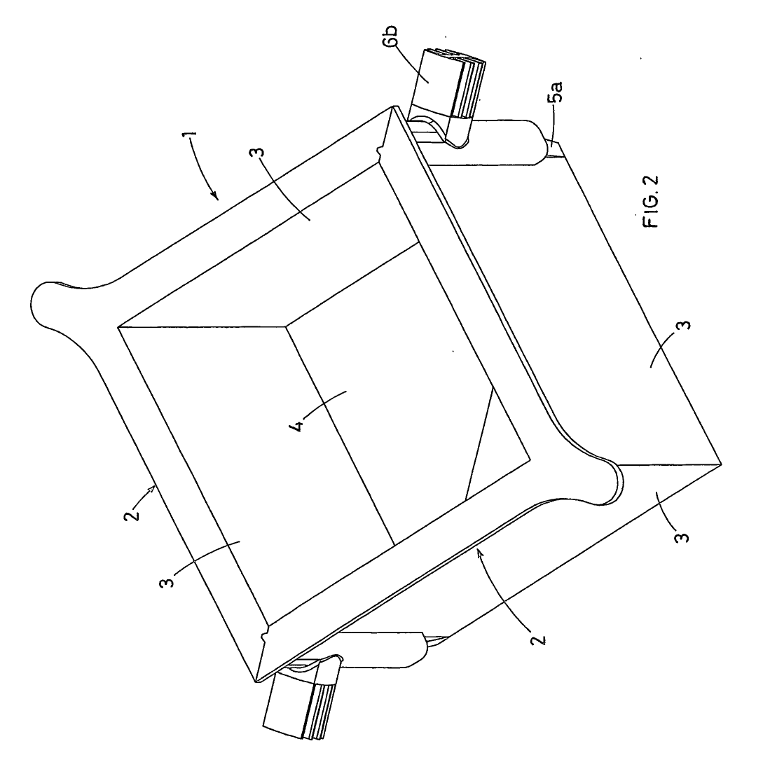

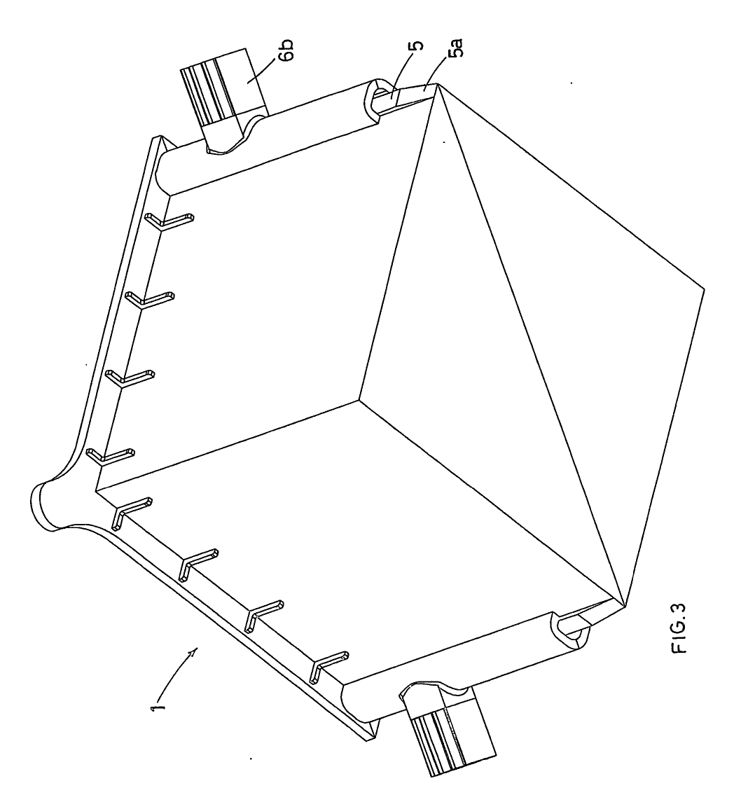

FIGS. 2 and 3 are axonometric views of the same framework in operational position, being a three-quarter top view a three-quarter bottom view, respectively.

With reference to FIG. 1, the framework (1) of the invention is composed of two identical modular semi-shells (2) obtained from moulding suitable plastic materials.

Each semi-shell (2) is formed of two adjacent vertical borders (3) positioned at 90°, built on the catheti of an horizontal triangular wall (4) at the base of the borders (3).

A vertical rib (5) is provided in external position on the free edge (3a) of each border (3), basically covering the entire height of the border (3) and featuring a lower tapered end (5a); in the embodiment of the invention shown in the enclosed figures, the rib (5) has a basically rectangular transversal cross-section.

When the two semi-shells (2) are matched, they are joined by means of two special joints (6) capable of mutually tightening the vertical free edges (3a) of the borders (3) of the two different semi-shells (2), two by two.

Each joint (6) consists in a sort of rectilinear jaw with basically C-shaped transversal cross-section, which frontally ends with two longitudinal wings (6a) symmetrically folded one towards the other; it being preferably provided that the joints (6) have a monolithic structure obtained from moulding plastic materials.

As illustrated above, the joint (6) is designed to slide from below upwards to be joined to the corresponding pair of vertical free edges (3a) of the two matched semi-shells (2).

The width of the longitudinal wings (6a) allows for engaging with the back of the two longitudinal ribs (5) located in external position on each vertical free edge (3a).

The insertion of the joints (6) is favoured by the lower tapered section (5a) of each rib (5).

It appears evident that the two semi-shells (2) can be released by pushing the two sliding joints (6) down.

With reference to the enclosed figures, it must be noted that each semi-shell (2) has a top flat stiffening edge (2a) with an appendix (2b) that projects outwards in the connection point between the two 90° borders (3).

Likewise, it must be noted that each joint (6) incorporates a rear perpendicular gripping plug (6b).

1. Modular framework used to mould concrete test blocks, characterised in that it is composed of two identical modular semi-shells (2) obtained from moulding suitable plastic materials, with each semi-shell (2) being formed of two vertical borders (3) positioned at 90° built on the catheti of a lower horizontal triangular wall (4), each of them having vertical ribs (5) in external position on the free edges (3a), preferably provided with a lower tapered end (5a), it being provided that one of the vertical ribs (5) is tightened to the adjacent identical rib (5) of the opposite semi-shell (2) by means of a special rectilinear joint (6) with suitable transversal cross-section and frontally provided with two longitudinal wings (6a) symmetrically folded one against the other, which can be exactly matched with the adjacent ribs (5) by sliding from below upwards, so that the longitudinal wings (6a) can engage with the back of the ribs (5).

2. Framework as defined in claim 1, characterised in that the rectilinear joint (6) has a monolithic structure obtained from moulding suitable plastic materials.

3. Framework as defined in claim 1, characterised in that the rectilinear joint (6) has a rear perpendicular gripping plug (6b).

4. Framework as defined in claim 1, characterised in that each semi-shell (2) has a top flat stiffening edge (2a) with an appendix (2b) that projects outwards in the connection point between the two 90° borders (3).
